(19) United States
(12) Patent Application Publication
(10) Pub. No.: US 2025/0148216 A1
(43) Pub. Date: May 8, 2025

(54) METHOD AND APPARATUS FOR TRAINING LARGE MODEL, ELECTRONIC DEVICE AND STORAGE MEDIUM

(71) Applicant: BAIDU INTERNATIONAL TECHNOLOGY (SHENZHEN) CO., LTD., Shenzhen (CN)

(72) Inventors: Chao Huang, Shenzhen (CN); Gang Qiao, Shenzhen (CN); Zhenpeng Zhan, Shenzhen (CN)

(73) Assignee: BAIDU INTERNATIONAL TECHNOLOGY (SHENZHEN) CO., LTD., Shenzhen (CN)

(21) Appl. No.: 19/018,557

(22) Filed: Jan. 13, 2025

(30) Foreign Application Priority Data
Jul. 12, 2024 (CN) 202410942657.3

(51) Int. Cl. G06F 40/35

(52) U.S. Cl. CPC G06F 40/35

(57) ABSTRACT

The disclosure discloses a method for training a large model, an apparatus for training a large model, an electronic device and a storage medium, and relates to a field of computer technologies, especially to a field of artificial intelligence technologies such as large model and deep learning. The method includes: obtaining a conversation sample, in which the conversation sample includes portraits of a plurality of roles, a plot containing the plurality of roles and a plurality of rounds of conversations among the plurality of roles; for any one of the plurality of roles, obtaining a predicted conversation sentence of the role by inputting the portraits of the plurality of roles, the plot and a historical conversation sentence corresponding to a sample conversation sentence of the role in the plurality of rounds of conversations into an initial large model; and obtaining a target large model by training the initial large model according to a difference between the predicted conversation sentence and the sample conversation sentence.

### CROSS REFERENCE TO RELATED APPLICATIONS

This application claims priority and benefits to Chinese Application No. 202410942657.3, filed on Jul. 12, 2024, the entire content of which is incorporated herein by reference.

### TECHNICAL FIELD

The disclosure relates to a field of computer technologies, in particular to a field of artificial intelligence technologies such as large model and deep learning, and especially to a method for training a large model, an apparatus for training a large model, an electronic device and a storage medium.

### BACKGROUND

The ability of role-playing of a large model is regarded as one of the important abilities of the large model. For users, what they need most is a customizable, highly anthropomorphic chat robot with emotion and warmth, which is realized by the role-playing ability of the large model. Therefore, how to improve the role-playing ability of the large model is an urgent problem to be solved.

### SUMMARY

The disclosure provides a method for training a large model, an apparatus for training a large model, an electronic device and a storage medium.

According to a first aspect of the disclosure, a method for training a large model is provided. The method includes:
obtaining a conversation sample, in which the conversation sample includes portraits of a plurality of roles, a plot containing the plurality of roles and a plurality of rounds of conversations among the plurality of roles;
for any one of the plurality of roles, obtaining a predicted conversation sentence of the role by inputting the portraits of the plurality of roles, the plot and a historical conversation sentence corresponding to a sample conversation sentence of the role in the plurality of rounds of conversations into an initial large model; and
obtaining a target large model by training the initial large model according to a difference between the predicted conversation sentence and the sample conversation sentence.

According to a second aspect of the disclosure, an apparatus for training a large model is provided. The apparatus includes:
a first obtaining module, configured to obtain a conversation sample, in which the conversation sample includes portraits of a plurality of roles, a plot containing the plurality of roles and a plurality of rounds of conversations among the plurality of roles;
a second obtaining module, configured to, for any one of the plurality of roles, obtain a predicted conversation sentence of the role by inputting the portraits of the plurality of roles, the plot and a historical conversation sentence corresponding to a sample conversation sentence of the role in the plurality of rounds of conversations into an initial large model; and
a training module, configured to obtain a target large model by training the initial large model according to a difference between the predicted conversation sentence and the sample conversation sentence.

According to a third aspect of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to implement the method described in the above embodiment.

According to a fourth aspect of the disclosure, a non-transitory computer-readable storage medium having computer instructions stored thereon is provided. The computer instructions are used to cause a computer to implement the method described in the above embodiment.

According to a fifth aspect of the disclosure, a computer program product including computer instructions is provided. When the computer instructions are executed by a processor, the steps of the method described in the above embodiment are implemented.

It should be understood that what is described in this section is not intended to identify key or important features of the embodiments of the disclosure, nor is it intended to limit the scope of the disclosure. Other features of the disclosure will be readily understood from the following description.

### BRIEF DESCRIPTION OF THE DRAWINGS

The attached drawings are for better understanding this scheme and do not constitute a limitation of this disclosure, in which:

FIG. 1 is a flowchart of a method for training a large model provided by an embodiment of the disclosure.

FIG. 2 is a flowchart of a method for training a large model provided by a further embodiment of the disclosure.

FIG. 3 is a flowchart of a method for training a large model provided by a further embodiment of the disclosure.

FIG. 4 is a flowchart of a method for training a large model provided by a further embodiment of the disclosure.

FIG. 5 is a schematic diagram of an apparatus for training a large model provided by an embodiment of the disclosure.

FIG. 6 is a block diagram of an electronic device used to implement the method for training a large model in the embodiment of the disclosure.

### DETAILED DESCRIPTION

Exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following description.

The following describes a method for training a large model, an apparatus for training a large model, an electronic device and a storage medium of the embodiment of the disclosure with reference to the accompany drawings.

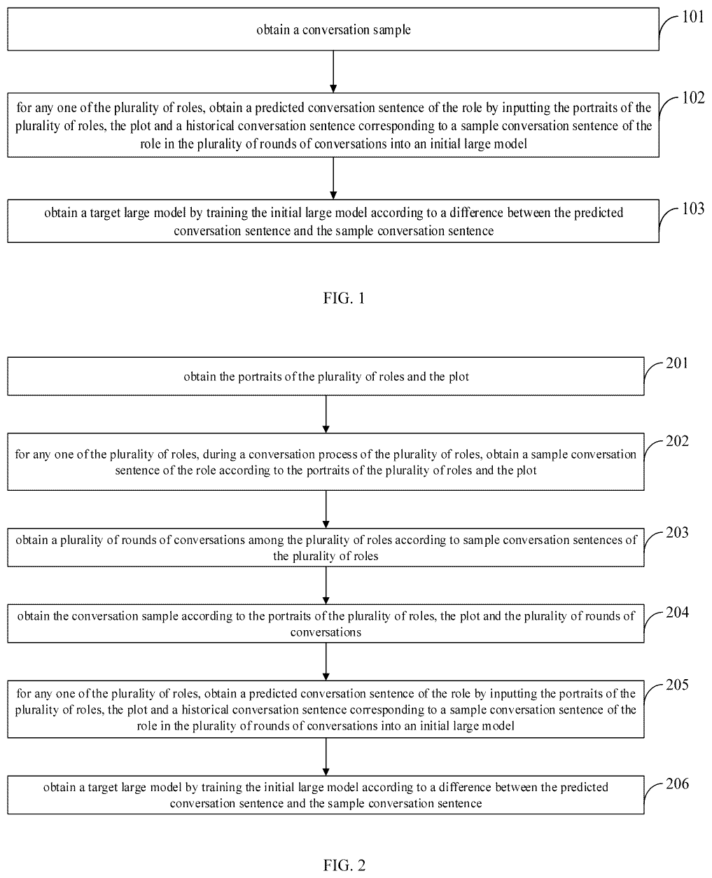

FIG. 1 is a flowchart of a method for training a large model provided by an embodiment of the disclosure.

The method for training a large model in the embodiment of the disclosure can be executed by the apparatus for training a large model in the embodiment of the disclosure. The apparatus can be configured in an electronic device.

The electronic device can be any device with computing capabilities, such as a personal computer, a mobile terminal and a server. The mobile terminal may be, for example, a vehicle-mounted device, a mobile phone, a tablet computer, a personal digital assistant, a wearable device and other hardware devices with various operating systems, touch screens and/or displays.

As illustrated in FIG. 1, the method for training a large model includes the following steps. At step 101, a conversation sample is obtained.

In this disclosure, the conversation sample includes, but is not limited to, portraits of a plurality of roles, a plot containing the plurality of roles, a plurality of rounds of conversations among the plurality of roles, and a difficulty level of the conversation sample.

The difficulty level of the conversation sample is determined according to the difficulty level of a plurality of rounds of conversations. The higher the difficulty level of the plurality of rounds of conversations, the higher the difficulty level of the conversation sample. The difficulty level of the plurality of rounds of conversations can be used to represent language complexity, amount of information and hierarchy level of information. For example, the higher the language complexity of the plurality of rounds of conversations, or the larger the amount of information, or the higher hierarchy level of the information, the higher the difficulty level of the plurality of rounds of conversations.

For example, the portrait of the role may include, but is not limited to, information such as the role's gender, an age, a personality, preferences and other information of the role. The attributes of portraits of different roles participating in the plurality of rounds of conversations may be the same or different. For example, the portrait of a role A includes portrait attributes such as gender, age and personality, while the portrait of a role B includes portrait attributes such as gender, age and preferences.

For example, a plot containing a plurality of roles can be generated based on portraits of the plurality of roles, or it can be taken from a movie or TV show, or from a literary work, or obtained by other means, without limitation.

For example, the above conversation sample obtained can be one or more, and there is no limit to this. If there are a plurality of conversation samples, for example, a conversation sample 1 may include a plurality of rounds of conversations between a role A and a role B, a conversation sample 2 may also include a plurality of rounds of conversations between the role A and the role B. A conversation sample 3 may include a plurality of rounds of conversations between the role A and a role C, and a plurality of rounds of conversations between the role B and the role C, and a plurality of rounds of conversations between the role B and a role D. A conversation sample 4 may include a plurality of rounds of conversations between a role A and a role B.

At step 102, for any one of the plurality of roles, a predicted conversation sentence of the role is obtained by inputting portraits of a plurality of roles, a plot and a historical conversation sentence corresponding to a sample conversation sentence of the role in a plurality of rounds of conversations into an initial large model.

The historical conversation sentence corresponding to the sample conversation sentence of any role in the plurality of rounds of conversations refers to any conversation sentence before the sample conversation sentence of the role in the plurality of rounds of conversations. The sample conversation sentence of the role can be any one of all the sample conversation sentences of the role in the plurality of rounds of conversations.

For example, a plurality of rounds of conversations in a certain conversation sample include a first sample conversation sentence of the role A, a first sample conversation sentence of the role B, a second sample conversation sentence of the role A, a second sample conversation sentence of the role B, a third sample conversation sentence of the role A and a third sample conversation sentence of the role B. Take the role A as an example, there is no historical conversation sentence corresponding to the first sample conversation sentence of the role A. The historical conversation sentences corresponding to the second sample conversation sentence of the role A include the first sample conversation sentence of the role A and the first sample conversation sentence of the role B. The historical conversation sentences corresponding to the third sample conversation sentence of the role A include the first sample conversation sentence of the role A, the first sample conversation sentence of the role B, the second sample conversation sentence of the role A, and the second sample conversation sentence of the role B.

In the disclosure, for any one of the plurality of roles, the portraits of the plurality of roles, the plot, and a historical conversation sentence corresponding to a sample conversation sentence of the role in a plurality of rounds of conversations are input into the initial large model, so as to predict a conversation sentence of the role and obtain a predicted conversation sentence of the role.

The number of predicted conversation sentences of any role can be the same as the number of sample conversation sentences of that role in the plurality of rounds of conversations.

For example, by calling a first large model, the predicted conversation sentence of any role can be obtained by predicting a conversation sentence of the role based on the portraits of the plurality of roles, the plot and the historical conversation sentence.

At step 103, a target large model is obtained by training the initial large model according to a difference between the predicted conversation sentence and the sample conversation sentence.

In this disclosure, for each predicted conversation sentence, a loss value is determined according to the difference between the predicted conversation sentence and the sample conversation sentence, and the parameter of the initial large model is adjusted according to the loss value, so that the conversation sentence of the role output by the large model is more accurate.

For example, the plurality of rounds of conversations of a certain conversation sample include the first sample conversation sentence of the role A, the first sample conversation sentence of the role B, the second sample conversation sentence of the role A, the third sample conversation sentence of the role A and the third sample conversation sentence of the role B.

For example, to train the conversation sentence of the role B in the large model, the portrait of the role A, the portrait of the role B, the plot containing the roles A and B, and the first sample conversation sentence of the role A are input into the initial large model to obtain a first predicted conversation sentence of the role B. The initial large model is trained according to a difference between the first predicted conversation sentence of the role B and the first sample conversation sentence of the role B.

Afterwards, the portrait of the role A, the portrait of the role B, the plot containing the roles A and B, the first sample conversation sentence of the role A, the first sample conversation sentence of the role B and the second sample conversation sentence of the role A are input into the large model whose parameter has been adjusted, to obtain a second predicted conversation sentence of the role B, and the large model is continued to be trained according to a difference between the second predicted conversation sentence of the role B and the second sample conversation sentence of the role B.

The portrait of the role A, the portrait of the role B, the plot containing the roles A and B, the first sample conversation sentence of the role A, the first sample conversation sentence of the role B, the second sample conversation sentence of the role A, the second sample conversation sentence of the role B and the third sample conversation sentence of the role A are then input into the large model whose parameter has been adjusted, to obtain a third predicted conversation sentence of the role B. The large model is continued to be trained according to a difference between the third predicted conversation sentence of the role B and the third sample conversation sentence of the role B.

In addition, the method for training a large model to output a conversation sentence of the role A is similar to the method for training a large model to output a conversation sentence of the role B, and the details are not repeated here.

In this disclosure, when training a large model to output a conversation sentence of a certain role, the large model can be trained by using conversation samples including portraits of the role, portraits of other roles that have conversation with this role, a plot containing a role B and other roles, and a plurality of rounds of conversations between this role and other roles.

For example, a plurality of conversation samples are obtained, which include many roles. For these roles, the large model can be trained to output the conversation sentences of these roles, to obtain the target large model. The large model can be trained for a plurality of roles simultaneously, to finally obtain the target big model.

After obtaining the target large model, a new portrait of a role can be obtained, and the role can be played by using the target large model. During the conversation between the user and the role, the target large model can output the conversation sentence of the role based on the portrait of the role and the historical conversation sentence between the user and the role.

In the embodiment of the disclosure, for any one of the plurality of roles, the portraits of the plurality of roles, the plot containing the plurality of roles, etc. are input into the initial large model for predicting a conversation sentence of the role, and the predicted conversation sentence of the role is obtained. According to the difference between the predicted conversation sentence of the role and the corresponding sample conversation sentence, the initial large model is trained to obtain the target large model. Therefore, the large model is trained according to the conversation sentences of different roles, which improves the role playing ability of the large model. Moreover, by controlling a matching degree between the role and the predicted conversation sentence through the plot containing a plurality of roles, the accuracy of the predicted conversation sentence can be improved, the cost of trial and error can be reduced, and the speed of model training can be improved.

FIG. 2 is a flowchart of a method for training a large model provided by an embodiment of the disclosure.

As illustrated in FIG. 2, the method for training a large model includes the following steps. At step 201, the portraits of the plurality of roles and the plot are obtained.

As a possible implementation, the portraits of the plurality of roles are obtained first, and then the plot containing the plurality of roles can be obtained according to the portraits of the plurality of roles by calling a second large model. Therefore, the second large model is used to obtain the plot based on the portraits of the plurality of roles, and thus the matching degree between the plot and the roles can be improved.

For example, the portraits of one or more roles among the plurality of roles can be determined from the portraits of a plurality of real roles.

For example, for one or more roles among the plurality of roles, a target portrait attribute is determined from candidate portrait attributes, and a target attribute value of the target portrait attribute is determined from candidate attribute values of the target portrait attribute, and a portrait of the role can be determined according to the target attribute value of the target portrait attribute. Therefore, the portrait of the role can be obtained by enumerating combinations of attributes.

There may be one or more target portrait attributes, and there are one or more candidate attribute values corresponding to one portrait attribute. For any target portrait attribute, one candidate attribute value can be randomly selected from its corresponding candidate attribute values as the target attribute value.

For example, reference portraits are obtained, and portraits of one or more roles among the plurality of roles are obtained according to the reference portraits by calling a third large model. For example, after obtaining a prompt for indicating the third large model to generate new portraits based on the reference portraits, the prompt is input to the third large model to obtain the portraits of the roles. The prompt may for example include information such as the reference portraits, the specified number of roles whose portraits are to be generated, and so on.

Therefore, the method for obtaining portraits of roles based on multi-source mixing can ensure the high quality and diversity of the portraits of roles.

For example, after obtaining the prompt for indicating the second large model to generate a plot based on the portraits of the plurality of roles, the prompt is input to the second large model for plot creation to obtain the plot containing the portraits of the plurality of roles. For example, the prompt may include the portraits of the plurality of roles, a requirement on the number of words included in the plot to be generated, and the like. For example, the plot can be generated by calling different second large models, thereby ensuring the diversity of the plot.

As another possible implementation, the plot can be generated first, and then the portraits of the roles are obtained according to the plot.

For example, the plot is obtained by calling the second large model, and then the portraits of the plurality of roles in the plot are obtained by calling the third large model. Therefore, the plot and the portraits of the plurality of roles are obtained through the second large model and the third large model, which can improve the matching degree between the plot and the roles.

For example, after obtaining a prompt for indicating the second large model to perform a plot generation task, the prompt is input to the second large model for plot creation. For example, for the same plot or different plots, the portraits of the plurality of roles included are obtained by calling different third large models, to achieve the diversity of the portraits of the plurality of roles.

For example, after obtaining a prompt for indicating the third large model to obtain the portraits of the plurality of roles in the plot based on the plot, the prompt is input to the third large model to acquire the portraits of the plurality of roles in the plot.

For example, after obtaining a prompt of “please generate a plot containing two roles”, the prompt is input into the second large model, to obtain the plot output by the second large model. Afterwards, a prompt of “the plot is [xxx], please extract the portraits of the roles in the plot from the given plot” is obtained, and the prompt is input into the third large model and the portraits of two roles are output by the third large model.

For example, the portrait of a target role of the plurality of roles is obtained, the plot can be obtained according to the portrait of the target role by calling the second large model, and the portraits of other roles of the plurality of roles except the target role can be obtained according to the plot by calling the third large model.

For example, based on the portrait of the target role, after obtaining a prompt for indicating the second large model to generate a plot containing the target role and other roles based on the portrait of the target role, the prompt is input into the second large model to obtain a plot containing a plurality of roles.

For example, based on the target role and the plot generated based on the portrait of the target role, after obtaining a prompt for indicating the third large model to acquire portraits of other roles in the plot based on the plot, the prompt is input to the third large model to acquire the portraits of other roles.

For example, after obtaining the portrait of the role A, a plot is generated based on the portrait of the role A by calling the second large model, because the plot also includes the role B, the portrait of the role B is generated based on the plot by calling the third large model.

Therefore, the plot can be generated based on the portraits of some roles of the plurality of roles, and then the portraits of other roles in the plot can be obtained based on the generated plot, which not only meets the personalized requirements of users for the portraits of roles and the plot, but also enriches the methods for obtaining the portraits of roles and the plot.

It should be noted that the first large model, the second large model and the third large model can be the same model or different models, which is not limited herein.

At step 202, for any one of the plurality of roles, during a conversation process of the plurality of roles, a sample conversation sentence of the role is generated according to the portraits of the plurality of roles and the plot.

For example, the sample conversation sentence of any role can be obtained according to the portraits of the plurality of roles, the plot and the current historical conversation sentence.

For example, during the conversation process between roles A and B, a first sample conversation sentence of the role A is obtained according to the portrait of the role A and the portrait of the role B, and then the first sample conversation sentence of the role B is obtained according to the portrait of the role A, the portrait of the role B, and the first sample conversation sentence of the role A. According to the portrait of the role A, the portrait of the role B, the first sample conversation sentence of the role A, and the first sample conversation sentence of the role B, a second sample conversation sentence of the role A is obtained. According to the portrait of the role A, the portrait of the role B, the first sample conversation sentence of the role A, the first sample conversation sentence of the role B and the second sample conversation sentence of the role A, a second sample conversation sentence of the role B is obtained.

In order to improve the difficulty level of conversation, for example, a target round whose conversation difficulty is to be increased and a target strategy for increasing the conversation difficulty level corresponding to the target round are determined. In the target round of conversation, a candidate conversation sentence of any role can be obtained according to the portraits of the plurality of roles and the plot, and then the target strategy is adopted to generate a sample conversation sentence of this role according to the portraits of the plurality of roles, the plot, the candidate conversation sentence and the historical conversation sentence of the candidate conversation sentence.

The target round can be, for example, the first round, the last round or any other round, which can be determined according to actual needs.

For example, the target strategy for increasing the difficulty level of conversation can be increasing the number of words in the conversation sentences, or generating conversation sentences in a certain mood, or generating conversation sentences using metaphor rhetoric.

In addition, the target strategies used to increase the difficulty of conversation can be different for different target rounds correspond to different target strategies.

For example, sample conversation sentence of a role can be generated by calling the first large model, using a target strategy according to the portraits of the plurality of roles, the plot, the candidate conversation sentence and the historical conversation sentence of the candidate conversation sentence.

For example, in the second round of conversation, the conversation sentence of a certain role is obtained by calling the first large model. If the conversation sentence has fewer words, the first large model can be re-called to generate a conversation sentence containing more words.

Therefore, for the conversation sentence of any role obtained based on the portraits of the plurality of roles and the plot, the target strategy for increasing the difficulty of conversation can be adopted to re-acquire a conversation sentence of this role, which increases the difficulty of the conversation sentence of the role and increases the difficulty of the conversation sample. Therefore, the large model can be trained using the conversation sample, which can improve the role-playing ability of the large model.

In order to further improve the quality of conversation, for example, the plot can be verified first, and the sample conversation sentence of any role can be obtained according to the portraits of the plurality of roles and the plot if the plot passes the verification.

Verifying the plot can be understood as verifying the rationality of the plot, for example, checking whether there are loopholes and contradictions in the plot.

Therefore, if the plot passes the verification, the sample conversation sentence of the role can be generated by using the plot, which improves the quality of the sample conversation sentence and further improves the quality of the conversation sample.

At step 203, a plurality of rounds of conversations among the plurality of roles are obtained according to sample conversation sentences of the plurality of roles in the conversation process of the plurality of roles.

In the disclosure, according to the sequence of sample conversation sentences of the plurality of roles in the conversation process of the plurality of roles, the sample conversation sentences of the plurality of roles are sorted in sequence to obtain multiple rounds of conversations among the plurality of roles.

At step 204, the conversation sample is obtained according to the portraits of the plurality of roles, the plot and the plurality of rounds of conversations.

For example, the conversation sample may include, but is not limited to, the portraits of the plurality of roles, the plot, and the plurality of rounds of conversations.

At step 205, for any one of the plurality of roles, a predicted conversation sentence of the role is obtained by inputting the portraits of the plurality of roles, the plot and a historical conversation sentence corresponding to the sample conversation sentence of the role in the plurality of rounds of conversations into an initial large model.

In this disclosure, step 205 can be implemented in any implementation of the embodiments of this disclosure, which is not repeated here.

At step 206, a target large model is obtained by training the initial large model according to a difference between the predicted conversation sentence and the sample conversation sentence.

In this disclosure, step 206 can be implemented in any implementation of the embodiments of this disclosure, which is not repeated here.

In the embodiment of the disclosure, in the conversation process of the plurality of roles, the sample conversation sentences of the plurality of roles are generated based on the acquired portraits of the plurality of roles and the plot containing the plurality of roles, so that multiple rounds of conversations among the plurality of roles can be obtained. Therefore, by controlling the matching degree between the roles and the multiple rounds of conversations through the plot, the quality of the multiple rounds of conversations can be improved, and the quality of conversation samples can be improved. Moreover, the large model is trained based on high-quality conversation samples, so that the quality of conversation sentences output by the large model can be improved.

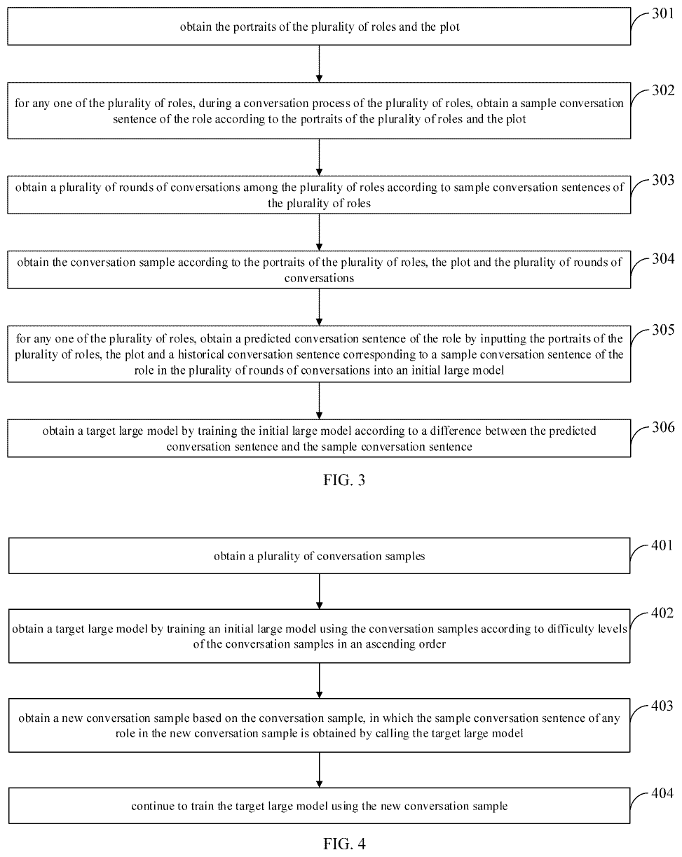

FIG. 3 is a flowchart of a method for training a large model provided by an embodiment of the disclosure.

As illustrated in FIG. 3, the method for training a large model includes the following steps. At step 301, the portraits of the plurality of roles and the plot are obtained.

In this disclosure, step 301 can be implemented in any implementation of the embodiments of this disclosure, which is not repeated here.

At step 302, for any one of the plurality of roles, during a conversation process of the plurality of roles, a sample conversation sentence of the role is obtained according to the portraits of the plurality of roles and the plot by calling a first large model corresponding to the role.

Different roles correspond to different first large models, that is, different roles can be played by different first large models.

For example, the role A is played by a large model m1, and the role B is played by a large model m2. The large model m1 and the large model m2 are two different large models. In the conversation process between the role A and the role B, the sample conversation sentence of the role A can be generated by calling the large model m1, and the sample conversation sentence of the role B can be generated by calling the large model m2.

In order to improve the personification of conversations among roles, for example, a language style of any role can be obtained, and a first large model corresponding to the role is called to obtain the sample conversation sentence of the role according to the portraits of the plurality of roles, the plot and the language style of the role.

Language style may include a speaking style of the role and an emotional information of the role. For example, speaking style may include humorous and seriousness, and the emotional information may include happy, angry and furious.

For example, according to the portraits of the plurality of roles, the plot and the language style of any role, after obtaining a prompt for indicating the first large model to generate a conversation sentence of the role that meets the language style requirement based on the portraits of the plurality of roles and the plot, the prompt is input to the first large model to obtain the sample conversation sentence of the role. For example, the prompt may include the portraits of the plurality of roles, the plot and the language style of the role, and it may also include requirement for a word count of the sample conversation sentence.

Therefore, the style and emotion of the conversation of the roles are controlled by the language style, which improves the personification of conversations of the roles and the quality of conversation.

At step 303, a plurality of rounds of conversations among the plurality of roles are obtained according to sample conversation sentences of the plurality of roles in the conversation process of the plurality of roles.

In this disclosure, step 303 can be implemented in any implementation of the embodiments of this disclosure, which is not repeated here.

At step 304, the conversation sample is obtained according to the portraits of the plurality of roles, the plot and the plurality of rounds of conversations.

In this disclosure, step 304 can be implemented in any implementation of the embodiments of this disclosure, which is not repeated here.

At step 305, for any one of the plurality of roles, a predicted conversation sentence of the role is obtained by inputting the portraits of the plurality of roles, the plot and a historical conversation sentence corresponding to the sample conversation sentence of the role in the plurality of rounds of conversations into an initial large model.

In this disclosure, step 305 can be implemented in any implementation of the embodiments of this disclosure, which is not repeated here.

At step 306, a target large model is obtained by training the initial large model according to a difference between the predicted conversation sentence and the sample conversation sentence.

In this disclosure, step 306 can be implemented in any implementation of the embodiments of this disclosure, which is not repeated here.

In the embodiment of the disclosure, different roles among the plurality of roles correspond to different first large models, and the sample conversation sentence of any role can be obtained by calling the first large model corresponding to the role. Therefore, in the conversation process of the plurality of roles, different large models are used to play different roles and obtain sample conversation sentences of corresponding roles, so that multiple rounds of conversations are obtained through mixing conversations, which improves the quality and diversity of conversation.

FIG. 4 is a flowchart of a method for training a large model provided by an embodiment of the disclosure.

As illustrated in FIG. 4, the method for training a large model includes the following steps.

At step 401, a plurality of conversation samples are obtained.

In this disclosure, step 401 can be implemented in any implementation of the embodiments of this disclosure, which is not repeated here.

At step 402, a target large model is obtained by training an initial large model using the conversation samples according to difficulty levels of the conversation samples in an ascending order.

For example, the difficulty level of the conversation sample can be determined according to an average number of words of all the sample conversation sentences in the multiple rounds of conversations in the conversation sample. For example, the larger the average number of words, the higher the difficult level of the conversation sample.

For example, it is determined whether the conversation difficulty is increased in the process of acquiring multiple rounds of conversations. If the conversation difficulty is increased, the difficulty level of the conversation sample can be determined according to the number of sample conversation sentences whose conversation difficulties have been increased, or the difficulty level of the conversation sample can be determined in combination with the priority of the adopted target strategy for increasing the conversation difficulty. The higher the priority of the target strategy, the higher the difficulty level of the sample conversation sentence obtained by using the target strategy.

The more the number of sample conversation sentences whose difficulty level have been increased, the higher the difficulty level of the conversation sample. The higher the priority of the adopted target strategy, the higher the difficulty level of the conversation sample.

For example, the priority of the target strategy adopted to increase the conversation difficulty of the sample conversation sentence is weighted, to obtain the difficulty level of the conversation sample.

It should be noted that the difficulty level of the conversation sample can be determined each time a conversation sample is obtained, or it can be determined one by one after obtaining a plurality of conversation samples, which is not limited herein.

For example, the initial large model can be trained by using conversation samples with low difficulty level, and then it can be trained by using conversation samples with high difficulty level, to obtain the target large model.

For example, when training the large model using the conversation sentence of any one of the plurality of roles, for the current conversation sample, the method of the above embodiments can be adopted to obtain the predicted conversation sentence of the role. A first intermediate large model is obtained by training the initial large model according to the difference between the predicted conversation sentence and the sample conversation sentence. A second intermediate large model is obtained by training the first intermediate large model using a next conversation sample, in which a difficulty level of the current conversation sample is less than a difficulty level of the next conversation sample. The second intermediate large model is trained with a next conversation sample of the next conversation sample until the target large model is obtained, in which a difficulty level of the next conversation sample is less than the difficulty level of the previous next conversation sample.

The initial large model can be trained in the above way for multiple roles simultaneously, and the target large model can be obtained finally.

At step 403, a new conversation sample is obtained based on the conversation sample, in which the sample conversation sentence of any role in the new conversation sample is obtained by calling the target large model.

For example, the sample conversation sentence of any role in the new conversation sample is obtained by calling the target large model, while the conversation sample sentences of other roles in the plurality of roles remain unchanged. That is, the sample conversation sentence of the role in the conversation sample can be replaced by the sample conversation sentence of the role obtained by calling the target large model.

For example, the sample conversation sentence of the role is obtained by inputting the portraits of the plurality of roles, the plot and the current historical conversation sentence into the target large model.

At step 404, the target large model is continued to be trained using the new conversation sample.

In this disclosure, the target large model is continued to be trained using the obtained new conversation sample, to continuously improve the role-playing ability of the large model through self-circulation learning.

In the embodiment of the disclosure, the target large model is obtained by training the initial large model using the conversation samples according to the difficulty levels of the conversation samples in an ascending order. A new conversation sample is obtained by using the target large model, and the target large model is continued to be trained using the new conversation sample. Therefore, the large model can be trained by using easy conversation samples first, and then using difficult conversation samples in combination with the self-circulation learning, which can not only improve the training speed of the model, but also further improve the role-playing ability of the large model.

In order to facilitate the understanding of the method for training a large model of the disclosure, the following examples are described. The method for training a large model of the disclosure includes the following four parts.

### 1. Role Portrait Generation Part

In order to ensure the diversity and quality of the generated portrait of a role, a method for generating a portrait of a role based on multi-source mixing is a universal and highly extensible method for generating a portrait of a role.

For example, the portrait of the role can be obtained based on a portrait of a real role, a portrait of a real role based on a combination of enumerated attributes, or a portrait of a fantasy role generated based on a reference portrait, so that the high quality and diversity of the generated portrait of the role are ensured through high-quality and diversified generation sources.

### 2. Plot Setting Part

The plot setting part exists to control a matching degree between roles and multiple rounds of conversations. If the corresponding multiple rounds of conversations are generated based on the role portrait generation part, low-quality conversation problems such as topic convergence may occur.

The plot setting part can adopt a variety of large models, and create the plot based on the input portrait of the role to ensure the diversity of the plot. Meanwhile, in order to ensure the quality of the generated plot, methods such as retrieval-augmented generation (RAG) and In-context Learning (ICL) can be introduced to strengthen the logic ability of the large model. Judgment model can also be introduced to judge the logic of the plot.

### 3. Multi-Round Conversation Generation Part

Based on the output of the first two parts, multiple rounds of conversations are generated. The chat method using mixing models is adopted, in which different large models play different roles. The conversation contents are presented based on the plot, and the conversation style and the conversation emotion can be controlled, to minimize the impact of the “assistant sense” of the generated results. It is also possible to control the level of difficulty of the generated conversations.

### 4. Model Training Part

Through the first three parts, a high-quality set of role-playing conversation data is obtained, which can be used for supervised fine-tuning training of large models. For example, the set of the data obtained in the previous parts are differentiated in terms of their level of difficulty. The large model starts learning from easier conversation sample first and gradually transitions to learning conversation samples with high difficulty level. After the model training is completed, the conversation sentence of the role in the set of conversation data is replaced with the conversation sample obtained by reasoning through the trained model, so as to get a new training set, and then the trained large model is continued to be trained with the new training set, so as to carry out self-circulation learning.

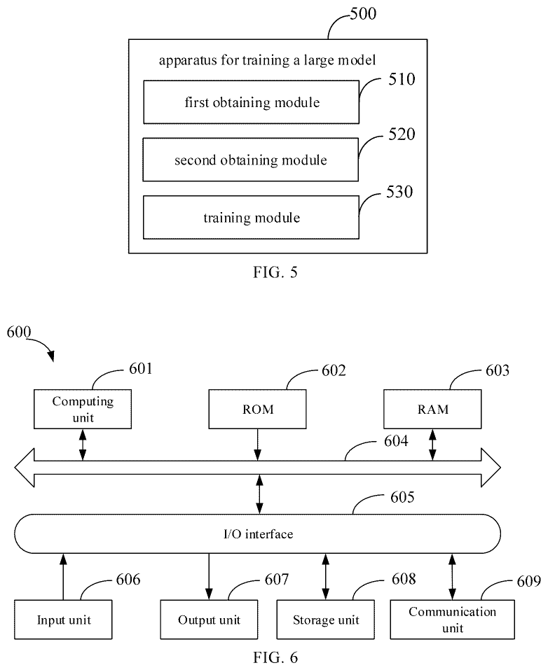

In order to realize the above embodiments, the embodiment of the disclosure also provides an apparatus for training a large model. FIG. 5 is a schematic diagram of an apparatus for training a large model provided by an embodiment of the disclosure.

As illustrated in FIG. 5, the apparatus 500 for training a large model includes:
a first obtaining module 510, configured to obtain a conversation sample, in which the conversation sample includes portraits of a plurality of roles, a plot containing the plurality of roles and a plurality of rounds of conversations among the plurality of roles;
a second obtaining module 520, configured to, for any one of the plurality of roles, obtain a predicted conversation sentence of the role by inputting the portraits of the plurality of roles, the plot and a historical conversation sentence corresponding to a sample conversation sentence of the role in the plurality of rounds of conversations into an initial large model; and
a training module 530, configured to obtain a target large model by training the initial large model according to a difference between the predicted conversation sentence and the sample conversation sentence.

Optionally, the first obtaining module 510 is configured to:
obtain the portraits of the plurality of roles and the plot;
for any one of the plurality of roles, during a conversation process of the plurality of roles, obtain a sample conversation sentence of the role according to the portraits of the plurality of roles and the plot;
obtain a plurality of rounds of conversations among the plurality of roles according to sample conversation sentences of the plurality of roles in the conversation process of the plurality of roles; and
obtain the conversation sample according to the portraits of the plurality of roles, the plot and the plurality of rounds of conversations.

Optionally, the first obtaining module 510 is configured to:
obtain the sample conversation sentence of the role according to the portraits of the plurality of roles and the plot by calling a first large model corresponding to the role, in which different roles in the plurality of roles correspond to different first large models.

Optionally, the first obtaining module 510 is configured to:
obtain a language style of the role; and
obtain the sample conversation sentence of the role according to the portraits of the plurality of roles, the plot and the language style by calling the first large model corresponding to the role.

Optionally, the first obtaining module 510 is configured to:
determine a target round whose conversation difficulty is to be increased and a target strategy for increasing the conversation difficulty corresponding to the target round;
in a conversation of the target round, obtain a candidate conversation sentence of the role according to the portraits of the roles and the plot; and
obtain the sample conversation sentence of the role by adopting the target strategy according to the portraits of the roles, the plot, the candidate conversation sentence and a historical conversation sentence of the candidate conversation sentence.

Optionally, the first obtaining module 510 is configured to:
verify the plot; and
in response to the plot passing the verification, obtain the sample conversation sentence of the role according to the portraits of the plurality of roles and the plot.

Optionally, the first obtaining module 510 is configured to:
obtain the portraits of the plurality of roles; and
generate the plot according to the portraits of the plurality of roles by calling a second large model.

Optionally, the first obtaining module 510 is configured to:
determine the portraits of the plurality of roles from portraits of a plurality of real roles;
for any role, determine a target portrait attribute from a candidate portrait attribute, determine a target attribute value of a target portrait attribute from a candidate attribute value of the target portrait attribute, and determine a portrait of the role according to the target attribute value of the target portrait attribute; or
obtain reference portraits, and obtain the portraits of the plurality of roles according to the reference portraits by calling a third large model.

Optionally, the first obtaining module 510 is configured to:
obtain a portrait of a target role in the plurality of roles;
obtain the plot according to the portrait of the target role by calling a second large model; and
obtain portraits of other roles in the plurality of roles except the target role by calling a third large model.

Optionally, the first obtaining module 510 is configured to:
obtain the plot by calling a second large model; and
obtain portraits of a plurality of roles in the plot according to the plot by calling a third large model.

Optionally, the training module 530 is configured to:
for a current conversation sample, obtain a first intermediate large model by training the initial large model according to the difference between the predicted conversation sentence and the sample conversation sentence;
obtain a second intermediate large model by training the first intermediate large model by using a next conversation sample, in which a difficulty level of the current conversation sample is less than a difficulty level of the next conversation sample; and
continue to train the second intermediate large model with a next conversation sample of the next conversation sample until the target large model is obtained, in which a difficulty level of the next conversation sample is less than the difficulty level of the previous next conversation sample.

Optionally, the apparatus also includes:
a third obtaining module, configured to obtain a new conversation sample based on the conversation sample, in which the sample conversation sentence of any role in the new conversation sample is obtained by calling the target large model; and
a training module 530, configured to continue to train the target large model using the new conversation sample.

It should be noted that the above explanation of the embodiments of the method for training a large model is also applicable to the apparatus for training a large model of this embodiment, which will not be repeated here.

In the embodiment of the disclosure, the large model is trained by using conversation sentences of different roles, which improves the role-playing ability of the large model. By controlling the matching degree between the roles and the predicted conversation sentences through the plot containing a plurality of roles, the accuracy of the predicted conversation sentences can be improved, the trial and error cost is reduced and the training speed of the model is improved.

According to the embodiments of the disclosure, the disclosure also provides an electronic device, a readable storage medium and a computer program product.

FIG. 6 is a schematic block diagram of an exemplary electronic device 600 that can be used to implement the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementations of the disclosure described and/or required herein.

As illustrated in FIG. 6, the electronic device 600 includes a computing unit 601 for performing various appropriate actions and processes based on computer programs stored in a Read-Only Memory (ROM) 602 or computer programs loaded from a storage unit 608 to a Random Access Memory (RAM) 603. In the RAM 603, various programs and data required for the operation of the electronic device 600 are stored. The computing unit 601, the ROM 602, and the RAM 603 are connected to each other through a bus 604. An input/output (I/O) interface 605 is also connected to the bus 604.

Components in the electronic device 600 are connected to the I/O interface 605, including: an input unit 606, such as a keyboard, a mouse; an output unit 607, such as various types of displays, speakers; a storage unit 608, such as a disk, an optical disk; and a communication unit 609, such as network cards, modems, and wireless communication transceivers. The communication unit 609 allows the electronic device 600 to exchange information/data with other devices through a computer network such as the Internet and/or various telecommunication networks.

The computing unit 601 may be various general-purpose and/or dedicated processing components with processing and computing capabilities. Some examples of the computing unit 601 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 601 executes the various methods and processes described above, such as the method for training a large model. For example, in some embodiments, the above method may be implemented as a computer software program, which is tangibly contained in a machine-readable medium, such as the storage unit 608. In some embodiments, part or all of the computer programs may be loaded and/or installed on the electronic device 600 via the ROM 602 and/or the communication unit 609. When the computer program is loaded on the RAM 603 and executed by the computing unit 601, one or more steps of each of the above method may be executed. Alternatively, in other embodiments, the computing unit 601 may be configured to perform the above method in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, Electrically Programmable Read-Only-Memories (EPROMs), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

According to the embodiment of the disclosure, the disclosure also provides a computer program product. When an instruction stored in the computer program product is executed by a processor, the method for training a large model proposed in the above embodiment of the disclosure is implemented.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for training a large model, comprising:
obtaining a conversation sample, wherein the conversation sample comprises portraits of a plurality of roles, a plot containing the plurality of roles and a plurality of rounds of conversations among the plurality of roles;
for any one of the plurality of roles, obtaining a predicted conversation sentence of the role by inputting the portraits of the plurality of roles, the plot and a historical conversation sentence corresponding to a sample conversation sentence of the role in the plurality of rounds of conversations into an initial large model; and
obtaining a target large model by training the initial large model according to a difference between the predicted conversation sentence and the sample conversation sentence.

2. The method of claim 1, wherein obtaining the conversation sample comprises:
obtaining the portraits of the plurality of roles and the plot;
for any one of the plurality of roles, during a conversation process of the plurality of roles, obtaining a sample conversation sentence of the role according to the portraits of the plurality of roles and the plot;
obtaining the plurality of rounds of conversations among the plurality of roles according to sample conversation sentences of the plurality of roles in the conversation process of the plurality of roles; and
obtaining the conversation sample according to the portraits of the plurality of roles, the plot and the plurality of rounds of conversations.

3. The method of claim 2, wherein obtaining the sample conversation sentence of the role according to the portraits of the plurality of roles and the plot, comprises:
obtaining the sample conversation sentence of the role according to the portraits of the plurality of roles and the plot by calling a first large model corresponding to the role, wherein different roles of the plurality of roles correspond to different first large models.

4. The method of claim 3, wherein obtaining the sample conversation sentence of the role according to the portraits of the plurality of roles and the plot by calling the first large model corresponding to the role, comprises:
obtaining a language style of the role; and
obtaining the sample conversation sentence of the role according to the portraits of the plurality of roles, the plot and the language style by calling the first large model corresponding to the role.

5. The method of claim 2, wherein obtaining the sample conversation sentence of the role according to the portraits of the plurality of roles and the plot, comprises:
determining a target round whose conversation difficulty is to be increased and a target strategy for increasing the conversation difficulty corresponding to the target round;
in a conversation of the target round, obtaining a candidate conversation sentence of the role according to the portraits of the roles and the plot; and
obtaining the sample conversation sentence of the role by adopting the target strategy according to the portraits of the roles, the plot, the candidate conversation sentence and a historical conversation sentence of the candidate conversation sentence.

6. The method of claim 2, wherein obtaining the sample conversation sentence of the role according to the portraits of the plurality of roles and the plot, comprises:
verifying the plot; and
in response to the plot passing the verification, obtaining the sample conversation sentence of the role according to the portraits of the plurality of roles and the plot.

7. The method of claim 2, wherein obtaining the portraits of the plurality of roles and the plot, comprises:
obtaining the portraits of the plurality of roles; and
generating the plot according to the portraits of the plurality of roles by calling a second large model.

8. The method of claim 7, wherein obtaining the portraits of the plurality of roles comprises at least one of:
determining the portraits of the plurality of roles from portraits of a plurality of real roles;
determining a target portrait attribute from a candidate portrait attribute, determining a target attribute value of a target portrait attribute from a candidate attribute value of the target portrait attribute, and determining a portrait of the role according to the target attribute value of the target portrait attribute; and
obtaining reference portraits, and obtaining the portraits of the plurality of roles according to the reference portraits by calling a third large model.

9. The method of claim 2, wherein obtaining the portraits of the plurality of roles and the plot, comprises:
obtaining a portrait of a target role of the plurality of roles;
obtaining the plot according to the portrait of the target role by calling a second large model; and
obtaining portraits of other roles of the plurality of roles except the target role according to the plot by calling a third large model.

10. The method of claim 2, wherein obtaining the portraits of the plurality of roles and the plot, comprises:
obtaining the plot by calling a second large model; and
obtaining portraits of a plurality of roles in the plot according to the plot by calling a third large model.

11. The method of claim 1, wherein obtaining a conversation sample, comprises: obtaining a plurality of conversation samples; wherein obtaining the target large model by training the initial large model according to the difference between the predicted conversation sentence and the sample conversation sentence, comprises: for a current conversation sample, obtaining a first intermediate large model by training the initial large model according to the difference between the predicted conversation sentence and the sample conversation sentence;
obtaining a second intermediate large model by training the first intermediate large model by using a next conversation sample, wherein a difficulty level of the current conversation sample is less than a difficulty level of the next conversation sample; and
continuing to train the second intermediate large model with a next conversation sample of the next conversation sample until the target large model is obtained, wherein a difficulty level of the next conversation sample is less than the difficulty level of the previous next conversation sample.

12. The method of claim 1, comprising:
obtaining a new conversation sample based on the conversation sample, wherein the sample conversation sentence of any role in the new conversation sample is obtained by calling the target large model; and
continuing to train the target large model using the new conversation sample.

13. An electronic device, comprising:
at least one processor; and
a memory communicatively connected to the at least one processor;
wherein the processor is configured to:
obtain a conversation sample, wherein the conversation sample comprises portraits of a plurality of roles, a plot containing the plurality of roles and a plurality of rounds of conversations among the plurality of roles;
for any one of the plurality of roles, obtain a predicted conversation sentence of the role by inputting the portraits of the plurality of roles, the plot and a historical conversation sentence corresponding to a sample conversation sentence of the role in the plurality of rounds of conversations into an initial large model; and
obtain a target large model by training the initial large model according to a difference between the predicted conversation sentence and the sample conversation sentence.

14. The electronic device of claim 13, wherein obtain the conversation sample comprises:
obtain the portraits of the plurality of roles and the plot;
for any one of the plurality of roles, during a conversation process of the plurality of roles, obtain a sample conversation sentence of the role according to the portraits of the plurality of roles and the plot;
obtain the plurality of rounds of conversations among the plurality of roles according to sample conversation sentences of the plurality of roles in the conversation process of the plurality of roles; and
obtain the conversation sample according to the portraits of the plurality of roles, the plot and the plurality of rounds of conversations.

15. The electronic device of claim 14, wherein obtain the sample conversation sentence of the role according to the portraits of the plurality of roles and the plot, comprises:
obtain the sample conversation sentence of the role according to the portraits of the plurality of roles and the plot by calling a first large model corresponding to the role, wherein different roles of the plurality of roles correspond to different first large models.

16. The electronic device of claim 15, wherein obtain the sample conversation sentence of the role according to the portraits of the plurality of roles and the plot by calling the first large model corresponding to the role, comprises:
obtain a language style of the role; and
obtain the sample conversation sentence of the role according to the portraits of the plurality of roles, the plot and the language style by calling the first large model corresponding to the role.

17. The electronic device of claim 14, wherein obtain the sample conversation sentence of the role according to the portraits of the plurality of roles and the plot, comprises:
determine a target round whose conversation difficulty is to be increased and a target strategy for increasing the conversation difficulty corresponding to the target round;
in a conversation of the target round, obtain a candidate conversation sentence of the role according to the portraits of the roles and the plot; and
obtain the sample conversation sentence of the role by adopting the target strategy according to the portraits of the roles, the plot, the candidate conversation sentence and a historical conversation sentence of the candidate conversation sentence.

18. The electronic device of claim 14, wherein obtain the sample conversation sentence of the role according to the portraits of the plurality of roles and the plot, comprises:
verify the plot; and
in response to the plot passing the verification, obtain the sample conversation sentence of the role according to the portraits of the plurality of roles and the plot.

19. A non-transitory computer-readable storage medium having computer instructions stored thereon, wherein the computer instructions are used to cause a computer to perform the method for training a large model, comprising:
obtaining a conversation sample, wherein the conversation sample comprises portraits of a plurality of roles, a plot containing the plurality of roles and a plurality of rounds of conversations among the plurality of roles;
for any one of the plurality of roles, obtaining a predicted conversation sentence of the role by inputting the portraits of the plurality of roles, the plot and a historical conversation sentence corresponding to a sample conversation sentence of the role in the plurality of rounds of conversations into an initial large model; and
obtaining a target large model by training the initial large model according to a difference between the predicted conversation sentence and the sample conversation sentence.

20. A computer program product comprising computer programs, wherein when the computer programs are executed by a processor, the steps of the method of claim 1 are implemented.
